(19) United States
(12) Patent Application Publication
(10) Pub. No.: US 2014/0028725 A1
(43) Pub. Date: Jan. 30, 2014

(54) ELECTRONIC DEVICE AND METHOD FOR DISPLAYING PRODUCT CATALOG

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(21) Appl. No.: 13/939,260

(22) Filed: Jul. 11, 2013

(30) Foreign Application Priority Data
Jul. 30, 2012 (TW) 101127525

(51) Int. Cl. G06T 3/60

(52) U.S. Cl. CPC G06T 3/60
USPC 345/650

(57) ABSTRACT

A method which provides for the display of a product catalog on a display screen of an electronic device. A current image of a scene in front of the electronic device is captured by an image capturing unit of the electronic device, and a face detected in the current image. A necessary rotational movement of the electronic device is first determined by detecting any apparent movement of a detected face. Then, the necessary movement of the device is carried out by a driver to follow any apparent movement of a user.

### BACKGROUND

1. Technical Field

Embodiments of the present disclosure relate to data displaying technology, particularly to an electronic device and method for displaying a product catalog on a display screen of the electronic device.

2. Description of Related Art

Currently, product catalogs are often displayed on a display screen of an electronic device statically. A viewing angle of the product catalog cannot be changed according to any movement of a user's face. Therefore, a prompt and efficient method for displaying the product catalog is desired.

### BRIEF DESCRIPTION OF THE DRAWINGS

FIG. 1 is a block diagram of an electronic device including a product catalog display system.

FIG. 2 is a block diagram of function modules of the product catalog display system included in the electronic device.

FIG. 3 is a flowchart of a method for displaying a product catalog on a display screen of the electronic device.

FIG. 4 is a schematic diagram of the electronic device.

FIGS. 5A-5C are schematic diagrams of the rotation of the electronic device and the product catalog according to a movement of a user.

### DETAILED DESCRIPTION

All of the processes described below may be embodied in and fully automated via function code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive, or other suitable storage medium.

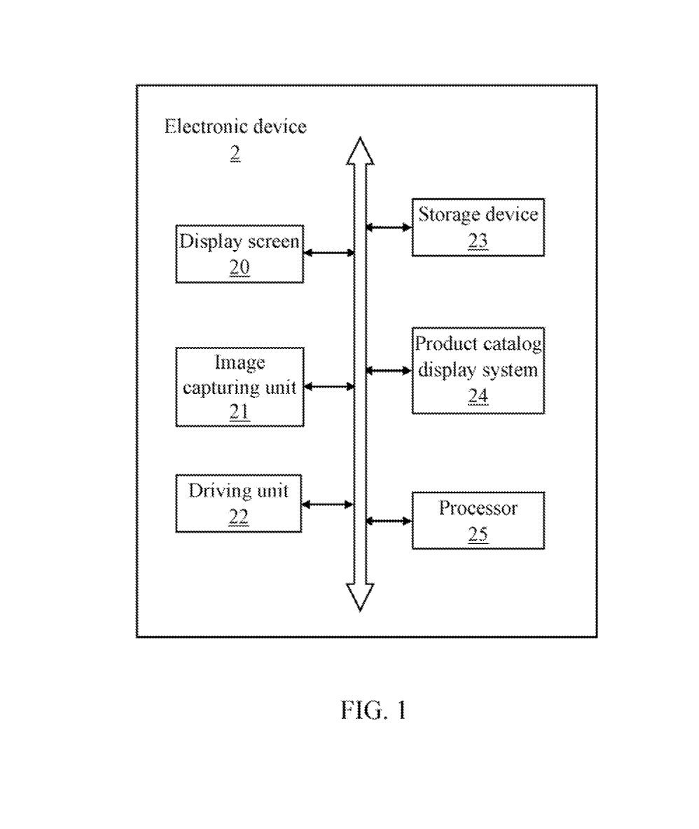

FIG. 1 is a block diagram of an electronic device including a product catalog display system 24. The electronic device 2 further includes a display screen 20, an image capturing unit 21, a driving unit 22, a storage device 23, and at least one processor 25. FIG. 1 illustrates only one example of the electronic device 2 that may include more or fewer components than illustrated or have a different configuration of the various components in other embodiments. The display screen 20 may be a liquid crystal display (LCD) or a cathode ray tube (CRT) display, for example.

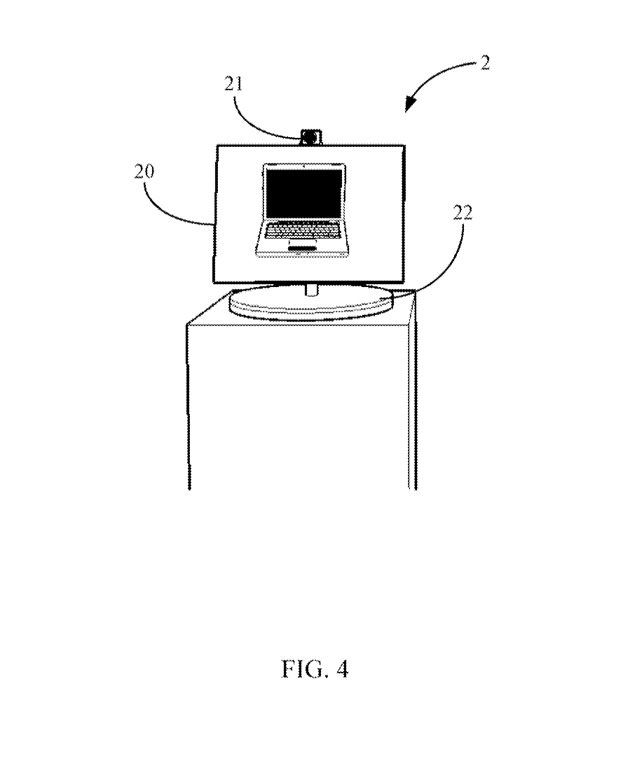

In one embodiment, the electronic device 2 is an electronic billboard. The image capturing unit 21 is positioned on a front part of the electronic device 2 (refer to FIG. 4), the image capturing unit 21 may be an Internet Protocol (IP) camera, and the image capturing unit 21 may be preset to capture thirty images per second (30 frames/s). That is to say, an interval between captures by the image capturing unit 21 may be about 0.03 seconds.

The driving unit 22 is positioned on the bottom of the electronic device 2, the driving unit 22 is used to control a movement of the electronic device 2. For example, the driving unit 22 may be a servomotor which includes an X-axis driving motor and a Y-axis driving motor. The storage device 23 may be a smart media card, a secure digital card, a compact flash card, or any other memory storage device. The storage device 23 stores source codes of the product catalog display system 24.

The product catalog display system 24 rotates the display screen 20 of a product catalog according to a movement of a user's face. A detailed description will be given in the following paragraphs. In one embodiment, the product catalog display system 24 includes computerized instructions in the form of one or more programs that are executed by the processor 25 and stored in the storage device 23 (or memory).

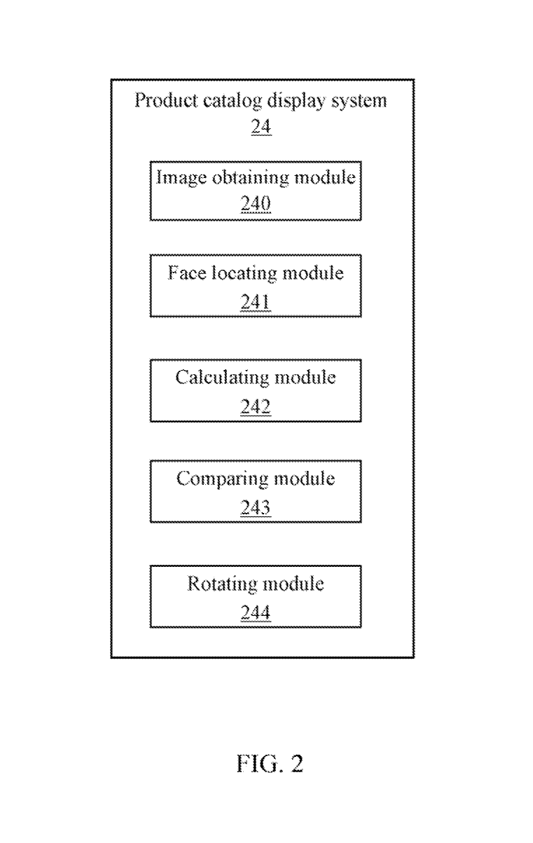

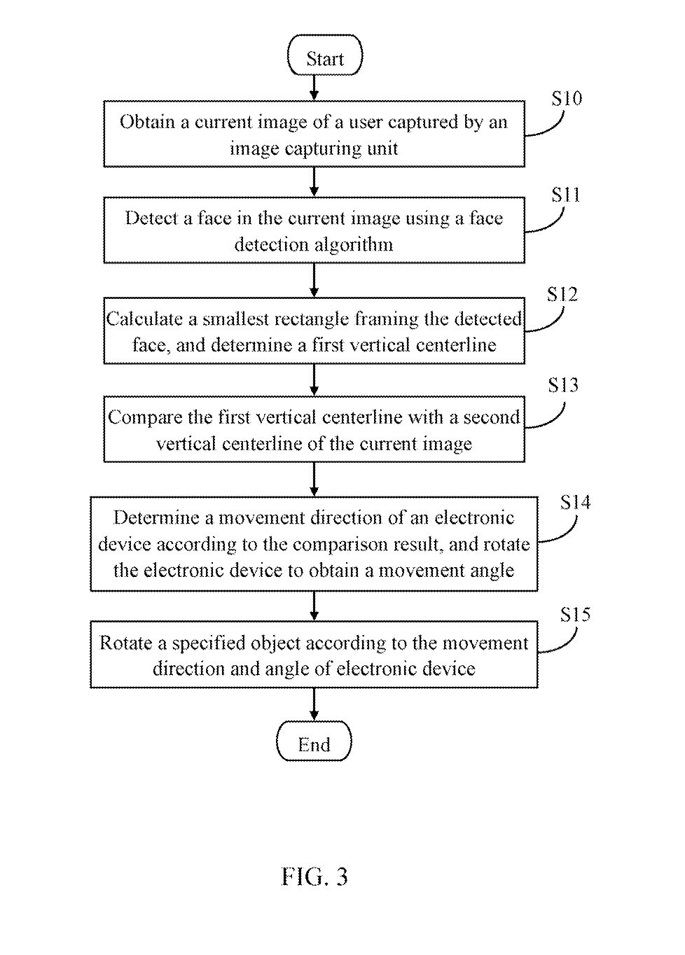

FIG. 2 is a block diagram of function modules of the product catalog display system 24 included in the electronic device 2. In one embodiment, the product catalog display system 24 includes one or more modules, for example, an image obtaining module 240, a face locating module 241, a calculating module 242, a comparing module 243, and a rotating module 244. In general, the word “module”, as used herein, refers to logic embodied in hardware, firmware, or to a collection of software instructions written in a programming language such as Java, C, or assembly. One or more software instructions in the modules are embedded in firmware such as in an EPROM. The modules described herein are implemented as software and/or hardware modules and are stored in any type of non-transitory computer-readable medium or other storage device. Some non-limiting examples of non-transitory computer-readable medium include CDs, DVDs, BLU-RAY, flash memory, and hard disk drives.

FIG. 3 is a flowchart of one embodiment of a method for displaying a product catalog on the display screen 20 of the electronic device 2. Depending on the embodiment, additional steps may be added, others removed, and the ordering of the steps may be changed.

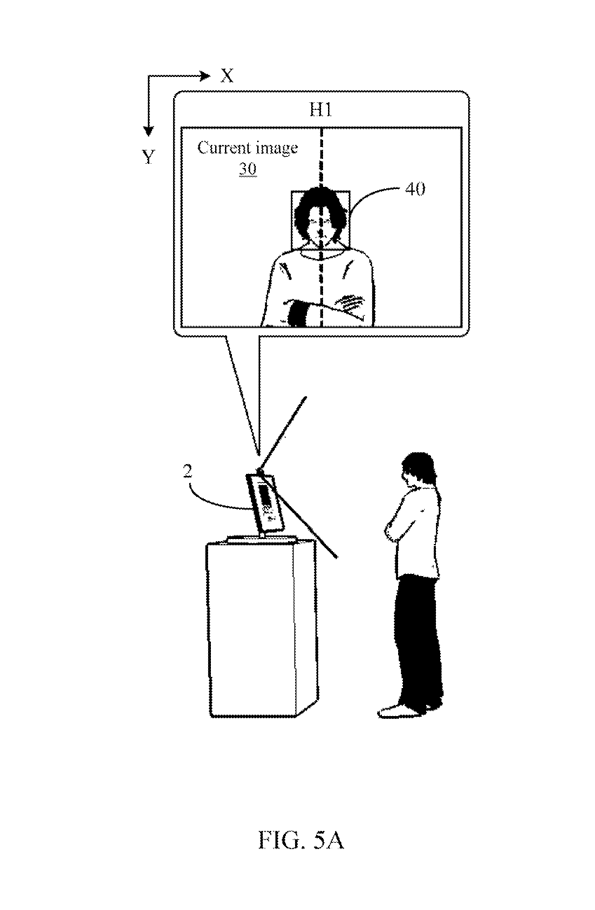

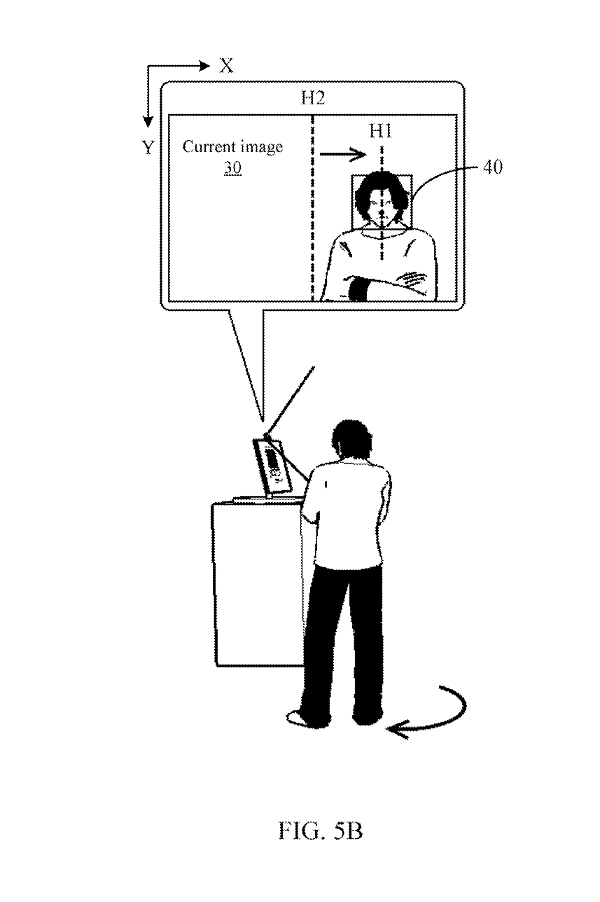

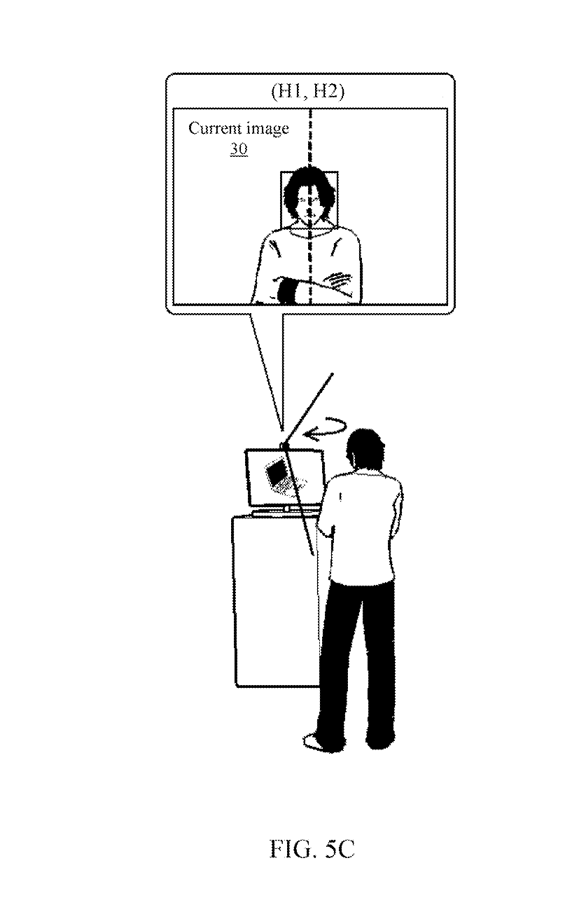

In step S10, the image obtaining module 240 obtains a current image 30 of a user, the current image 30 having been captured by the image capturing unit 21 (refer to FIG. 5A).

In step S11, the face locating module 241 detects a face in the current image 30 according to a face detection algorithm. In one embodiment, the face locating module 241 detects a face using a skin color model in YCbCr space or a face template matching method. For example, in YCbCr, Y is the brightness (luma), Cb is blue minus luma (B−Y), and Cr is red minus luma (R−Y). One example of an equation for determining the existence of facial skin is as follows.

$$P ( x , y ) = \{ \begin{matrix}1 , & if [ 135 \leq Cr ( x , y ) \leq 156 ] ⋂ [ 108 \leq Cb ( x , y ) \leq 123 ] \\ 0 , & otherwise\end{matrix}$$

In the equation, “P” represents a pixel in the current image, and “(x, y)” represents coordinates of “P”. In one embodiment, a value of Cr(x, y) ranges from 135 to 156, a value of Cb(x, y) ranges from 108 to 123. In other embodiments, the values of the Cr(x, y) and the Cb(x, y) may be in any other suitable range. If a value of the P(x, y) is 1, the face locating module 241 determines that an examined area in the current image is facial skin. If a value of the P(x, y) is 0, the face locating module 241 determines that an examined area in the current image is not facial skin.

In step S12, the calculating module 242 calculates a smallest rectangle 40 framing the detected face, and determines a first vertical centerline “H1” of the smallest rectangle 40 according to coordinates of a center point of the smallest rectangle 40 (refer to FIG. 5A). A panning motion of the electronic device 2 to follow a movement of the user is determined by a movement of a position of the first vertical centerline “H1”. For example, if the first vertical center lien “H1” moves rightward, the user is deemed to move on the right hand side.

In step S13, the comparing module 243 determines a movement direction (apparent movement) of the smallest rectangle 40 of the detected face by comparing the first vertical centerline “H1” with a second vertical centerline “H2” of the current image 30 (refer to FIG. 5B). The second vertical centerline “H2” is determined according to coordinates of a center point of the current image 30. A point of origin of a coordinate system of the current image 30 may be a top-left point of the current image 30.

In detail, the comparing module 243 calculates a deviation value between X-axis coordinates of the first vertical centerline “H1” (e.g., X=x1) of the smallest rectangle 40 and the second vertical line “H2” (e.g., X=x0) of the current image 30, and determines the movement direction of the smallest rectangle 40 of the detected face according to the deviation value. For example, if a deviation value is greater than zero (i.e., x1−x0>0), the movement direction of the smallest rectangle 40 is in a positive direction of the X-axis, that is, the movement direction of the user's face is to the right.

In another embodiment, if more than one face is detected in the current image 30 by the face locating module 241 in step S11, the calculating module 242 calculates a smallest rectangle for each of the detected faces in the current image 30, in step S12. Then, the comparing module 243 selects the smallest rectangle which has the maximum area and calculates a deviation value between X-axis coordinates of a third vertical centerline of the selected smallest rectangle and the second vertical line of the current image 30, and determines the movement direction of the selected smallest rectangle according to the deviation value. The area of the smallest rectangle of a user's face is larger when a user is closer to the electronic device 2.

In step S14, the rotating module 244 determines a movement direction (necessary movement) of the electronic device 2 according to the movement direction of the smallest rectangle 40 of the detected face, and rotates the electronic device 2 with a preset movement speed (e.g., 1 m/s) according to the determined movement direction of the electronic device 2. Rotation of the electronic device 2 is stopped when the first vertical centerline “H1” of the smallest rectangle 40 is overlapped with the second vertical centerline “H2” of the current image 30 (refer to FIG. 5C). The rotating module 244 obtains a measure of angular movement (movement angle) of the electronic device 2 when the electronic device 2 is rotated. In one embodiment, the rotating module 244 controls the electronic device 2 to rotate using the driving unit 22 of the electronic device 2.

A method for determining the movement direction (necessary movement) of the electronic device 2 is as follows. The rotating module 244 determines that the movement direction of the electronic device 2 is rightward, if the deviation value is greater than zero (i.e., the movement direction of the smallest rectangle 40 of the detected face is in the positive direction of the X-axis). If the deviation value is less than zero (i.e., the movement direction of the smallest rectangle 40 of the detected face is in a negative direction of the X-axis), the rotating module 244 determines that the movement direction of the electronic device 2 is leftward. If the deviation value is equal to zero, the electronic device 2 is not rotated.

For example, referring to FIG. 5B, “x1” represents the X-axis coordinate of the first vertical centerline “H1”, “x0” represents the X-axis coordinate of the second vertical centerline “H2”. If (x1−x0)>0, the rotating module 244 determines that the movement direction of the electronic device 2 is rightward. If (x1−x0)<0, the rotating module 244 determines that the movement direction of the electronic device 2 is leftward. If (x1−x0)=0, the rotating module 244 determines that there is no need to rotate the electronic device 2.

In step S15, the rotating module 244 rotates the display of a product catalog (or other specified object) according to the movement direction and the movement angle of the electronic device 2 to follow the movement of a user in relation to the electronic device 2. The product catalog may be a virtual three dimensional (3D) image of a product (e.g., a notebook computer). The virtual 3D image may be set using a 3D software tool for creating animation and interactivity.

For example, if the movement direction of the electronic device 2 is rightward, the product catalog rotates rightward with the movement angle (e.g., 30 degrees) of the electronic device 2. If the movement direction of the electronic device 2 is leftward, the product catalog (e.g., the virtual 3D image of the product) rotates leftward with the movement angle of the electronic device 2. For example, if the electronic device 2 moves 30 degrees leftward, the product catalog also moves 30 degrees leftward.

It should be emphasized that the above-described embodiments of the present disclosure, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for displaying a specified object on a display screen of an electronic device, the method comprising:
obtaining a current image captured by an image capturing unit of the electronic device, and detecting a face in the current image;
calculating a smallest rectangle framing the detected face, and determining a first vertical centerline of the smallest rectangle;
determining a movement direction of the smallest rectangle of the detected face by comparing the first vertical centerline of the smallest rectangle with a second vertical centerline of the current image;
determining a movement direction of the electronic device according to the movement direction of the smallest rectangle of the detected face;
rotating the electronic device according to the movement direction of the electronic device using a driving unit of the electronic device, and obtaining a movement angle of the electronic device when the electronic device is rotated; and
rotating the specified object on the display screen according to the movement direction and the movement angle of the electronic device.

2. The method according to claim 1, wherein the movement direction of the smallest rectangle of the detected face is determined by:
calculating a deviation value between X-axis coordinates of the first vertical centerline of the smallest rectangle and the second vertical line of the current image; and
determining the movement direction of the smallest rectangle of the detected face according to the deviation value.

3. The method according to claim 2, wherein the movement direction of the smallest rectangle of the detected face is in a positive direction of the X-axis when the deviation value is greater than zero, or the movement direction of the smallest rectangle of the detected face is in a negative direction of the X-axis when the deviation value is less than zero.

4. The method according to claim 2, wherein the movement direction of the electronic device is determined by:
determining that the movement direction of the electronic device is rightward when the deviation value is greater than zero; and
determining that the movement direction of the electronic device is leftward when the deviation value is less than zero.

5. The method according to claim 1, further comprising:
detecting a plurality of faces in the current image, calculating a smallest rectangles of each of the detected faces, and selecting the smallest rectangle having a maximum area;
calculating a deviation value between X-axis coordinates of a third vertical centerline of the selected smallest rectangle and the second vertical line of the current image, and determining the movement direction of the selected smallest rectangle according to the deviation value.

6. The method according to claim 1, further comprising:
stopping rotating the electronic device when the first vertical centerline of the smallest rectangle is overlapped with the second vertical centerline of the current image.

7. A electronic device, comprising:
a processor;
a display screen;
a storage device storing a plurality of instructions, which when executed by the processor, causes the processor to:
obtain a current image captured by an image capturing unit of the electronic device, and detect a face in the current image;
calculate a smallest rectangle framing the detected face, and determine a first vertical centerline of the smallest rectangle;
determine a movement direction of the smallest rectangle of the detected face by comparing the first vertical centerline of the smallest rectangle with a second vertical centerline of the current image;
determine a movement direction of the electronic device according to the movement direction of the smallest rectangle of the detected face;
rotate the electronic device according to the movement direction of the electronic device using a driving unit of the electronic device, and obtain a movement angle of the electronic device when the electronic device is rotated; and
rotate a specified object on the display screen according to the movement direction and the movement angle of the electronic device.

8. The electronic device according to claim 7, wherein the movement direction of the smallest rectangle of the detected face is determined by:
calculating a deviation value between X-axis coordinates of the first vertical centerline of the smallest rectangle and the second vertical line of the current image; and
determining the movement direction of the smallest rectangle of the detected face according to the deviation value.

9. The electronic device according to claim 8, wherein the movement direction of the smallest rectangle of the detected face is in a positive direction of the X-axis when the deviation value is greater than zero, or the movement direction of the smallest rectangle of the detected face is in a negative direction of the X-axis when the deviation value is less than zero.

10. The electronic device according to claim 8, wherein the movement direction of the electronic device is determined by:
determining that the movement direction of the electronic device is rightward when the deviation value is greater than zero; and
determining that the movement direction of the electronic device is leftward when the deviation value is less than zero.

11. The electronic device according to claim 7, wherein the plurality of instructions further comprise:
detecting a plurality of faces in the current image, calculating a smallest rectangles of each of the detected faces, and selecting the smallest rectangle having a maximum area;
calculating a deviation value between X-axis coordinates of a third vertical centerline of the selected smallest rectangle and the second vertical line of the current image, and determining the movement direction of the selected smallest rectangle according to the deviation value.

12. The electronic device according to claim 7, wherein the plurality of instructions further comprise:
stopping rotating the electronic device when the first vertical centerline of the smallest rectangle is overlapped with the second vertical centerline of the current image.

13. A non-transitory storage medium having stored thereon instructions that, when executed by a processor of an electronic device, causes the electronic device to perform a method, the method comprising:
obtaining a current image captured by an image capturing unit of the electronic device, and detecting a face in the current image;
calculating a smallest rectangle framing the detected face, and determining a first vertical centerline of the smallest rectangle;
determining a movement direction of the smallest rectangle of the detected face by comparing the first vertical centerline of the smallest rectangle with a second vertical centerline of the current image;
determining a movement direction of the electronic device according to the movement direction of the smallest rectangle of the detected face;
rotating the electronic device according to the movement direction of the electronic device using a driving unit of the electronic device, and obtaining a movement angle of the electronic device when the electronic device is rotated; and
rotating a specified object on a display screen of the electronic device according to the movement direction and the movement angle of the electronic device.

14. The non-transitory storage medium according to claim 13, wherein the movement direction of the smallest rectangle of the detected face is determined by:
calculating a deviation value between X-axis coordinates of the first vertical centerline of the smallest rectangle and the second vertical line of the current image; and
determining the movement direction of the smallest rectangle of the detected face according to the deviation value.

15. The non-transitory storage medium according to claim 14, wherein the movement direction of the smallest rectangle of the detected face is in a positive direction of the X-axis when the deviation value is greater than zero, or the movement direction of the smallest rectangle of the detected face is in a negative direction of the X-axis when the deviation value is less than zero.

16. The non-transitory storage medium according to claim 14, wherein the movement direction of the electronic device is determined by:
determining that the movement direction of the electronic device is rightward when the deviation value is greater than zero; and
determining that the movement direction of the electronic device is leftward when the deviation value is less than zero.

17. The non-transitory storage medium according to claim 17, wherein the method further comprises:
detecting a plurality of faces in the current image, calculating a smallest rectangles of each of the detected faces, and selecting the smallest rectangle having a maximum area;
calculating a deviation value between X-axis coordinates of a third vertical centerline of the selected smallest rectangle and the second vertical line of the current image, and determining the movement direction of the selected smallest rectangle according to the deviation value.

18. The non-transitory storage medium according to claim 13, wherein the method further comprises:
stopping rotating the electronic device when the first vertical centerline of the smallest rectangle is overlapped with the second vertical centerline of the current image.
